(19) United States
(12) Patent Application Publication
(10) Pub. No.: US 2014/0161935 A1
(43) Pub. Date: Jun. 12, 2014

(54) PROCESSED FOOD

(71) Applicants: Katherine P. Boebel, W. Alexandria, OH (US); Lynnette Sue GLEABELL, Lewishburg, OH (US); Bebecca Massie GREY, Brookville, OH (US)

(72) Inventors: Katherine P. Boebel, W. Alexandria, OH (US); Lynnette Sue GLEABELL, Lewishburg, OH (US); Bebecca Massie GREY, Brookville, OH (US)

(21) Appl. No.: 13/707,308

(22) Filed: Dec. 6, 2012

(51) Int. Cl. A23K 1/18

(52) U.S. Cl. CPC A23K 1/1846
USPC 426/72; 426/656; 426/615; 426/634; 426/629; 426/618; 426/89

(57) ABSTRACT

A processed food has an inoffensive or pleasant aroma. The aroma may be developed by including carbohydrate-rich protein sources and limiting non-nutritive acids, plasticizers, and/or artificial colorants. The aroma may be developed or maintained by including anti-oxidants and/or limiting animal digests or animal by-products added after cooking the food. The food may exclude or have limited content of rendered products of bovine or porcine origin.

### FIELD OF THE INVENTION

This invention relates generally to processed foods, in particular, but not limited to, processed foods for pets.

### BACKGROUND OF THE INVENTION

Processed foods may include additives to prolong shelf stability, e.g., by preventing spoilage caused by microbial growth or oxidation. Some stability additives may also be intended to prolong the palatability of a processed food, under storage conditions where the food might otherwise seem stale or less flavorful after the end of the time necessary to produce, package, distribute, sell, and store the food. The success of these additives in preserving flavor over time is highly variable in different products.

There remains a need for processed foods which are shelf-stable. There remains a need for processed foods which are palatable over typical time delays between production and consumption. There remains a need for processed foods with stable palatability profiles that consider senses other than taste that are relevant to eating experiences, such as smell.

### SUMMARY OF THE INVENTION

In some aspects, this disclosure relates to a processed food. The processed food may comprise at least 60% by weight of one or more carbohydrate-rich protein sources. The processed food may comprise less than 0.5% by weight of non-nutritive acid. The processed food may comprise less than 5% by weight rendered products of bovine or porcine origin. The processed food may be free of non-nutritive acid. The processed food may be free of artificial preservatives. The processed food may be free of added sugars. The processed food may comprise a fruit or vegetable. The processed food may be free of artificial colorants. The processed food may be free of artificial colorants comprising a cation reagent or substratum. The processed food may be free of plasticizers. The processed food may comprise Vitamin C. The processed food may comprise at least 80 IU/kg of Vitamin E. The processed food may comprise at least 25 ppm of Vitamin C.

The carbohydrate-rich protein source may be selected from the group consisting of corn, soy, peas, other beans or legumes, and combinations thereof. The carbohydrate-rich protein source may comprise a protein-enriched fraction of a cereal, legume, or bean. The processed food may comprise at least 10% by weight of the concentrated vegetable protein. The processed food may comprise at least 10% by weight of the concentrated vegetable protein and at least 60% by weight of one or more other carbohydrate-rich protein sources. The carbohydrate-rich protein source may comprise corn gluten meal. The carbohydrate-rich protein source may comprise soy protein isolate.

The processed food may be a complete diet for a dog. The processed food may have a coating applied after cooking. The coating, if present, may be substantially free of animal digest or animal by-product. The processed food may be a complete diet for a cat.

In some aspects, the disclosure relates to a method for providing or maintaining an inoffensive aroma in a processed food. The method may comprise compounding a food which comprises carbohydrate-rich protein sources. The method may comprise excluding from the food non-nutritive acid in an amount greater than 5% by weight of the food. The method may comprise excluding from the food rendered products of bovine or porcine origin in an amount greater than 5% by weight of the food.

### DETAILED DESCRIPTION OF THE INVENTION

As used herein, “pet” means dogs, cats, and/or other domesticated animals of like nutritional needs to a dog or a cat. For example, other domesticated animals of like nutritional needs to a cat may include minks and ferrets, who can survive indefinitely and healthily on a nutritional composition designed to meet the nutritional needs of cats. It will be appreciated by one of skill in the art that dogs and cats have nutritional needs which differ in key aspects. At a fundamental level, dogs are omnivores, whereas cats are obligate carnivores. Further, nutritional needs are not necessarily consistent with phylogenetic or other non-nutritional classifications.

As used herein, the term “added” refers to an ingredient or element that is supplemented in a food, and excludes endogenous sources of the ingredient or element which are added for nutritive purposes. For example, a food free of added sugars may nonetheless contain sugars that are part of other food ingredients, such as fruits, vegetables, or grains.

As used herein, unless otherwise stated for a particular parameter, the term “about” refers to a range that encompasses an industry-acceptable range for inherent variability in analyses or process controls, including sampling error. Consistent with the Model Guidance of AAFCO, inherent variability is not meant to encompass variation associated with sloppy work or deficient procedures, but, rather, to address the inherent variation associated even with good practices and techniques.

As used herein, the term “complete diet” refers a food which is a nutritionally adequate feed for an animal, is compounded to be fed as the sole ration, and is capable of maintaining life without any additional substance being consumed except water.

As used herein, the term “free of” refers to a product having less than 10 ppm of the specified element or additive, or, if the limit of detection for the specified element or additive is greater than 10 ppm, less than the limit of detection.

As used herein, “processed food” refers to a food which is significantly modified from its natural state, as by mechanical alteration (such as grinding or chopping), combination with other food products or additives, and/or cooking. As used herein, “processed food” excludes foods which substantially maintain their natural state after processing. For example, fresh produce may be washed, sorted, coated or treated, and packaged, but remain substantially in its natural state after processing, and would not be considered a “processed food” for the purpose of this disclosure.

Unless otherwise described, all percentages are weight percent of the food on an as-fed basis.

Palatability is generally associated with taste, but it is well known that other senses, particularly smell, can play an important role in determining whether a food will be desirable or enjoyable. With some notable exceptions, an undesirable aroma may discourage tasting a food, or interfere with an otherwise pleasant flavor. Undesirable aroma can arise from a food itself, or from processing conditions, or from degradation (as by microbes or oxidation), or from a combination of these factors.

The control of microbial growth is also important for food safety, and there are several approaches that can be used to make a processed food less hospitable to bacteria and fungi. One approach is to use artificial preservatives, such as benzoates, including sodium benzoate, nitrites or nitrates, sulfites, polyphosphates, butylated hydroxyanisole or butylated hydroxytoluene (BHA/BHT), or combinations thereof. Another approach is to control the water activity and/or moisture content of the food. Processed foods may be dried or dehydrated to a moisture content that limits or entirely prevents microbial growth. Alternately or in addition to drying or dehydrating the food, additives may be used to reduce the water activity, or the water available for chemical reactions or microbial use. For example, sugars may be added in amounts sufficient to lower the water activity to a point where microbial growth is inhibited. For example, the water activity may be lowered below 0.5, or below 0.3, or even below 0.2. In different food bases (e.g., starch-based, protein-based, etc.), these approaches may have different effects on different aspects of palatability, such as appearance, taste, and aroma. In many products, a combination of approaches is used, for example, adding sugars and artificial preservatives to dry foods.

Yet another approach is to add non-nutritive acid to the food to acidify the food. Acidification may render the food less hospitable to common microorganisms. Acidification may also slow or prevent oxidation. Common non-nutritive acids include, but are not limited to, phosphoric acid, citric acid, hydrochloric acid, tartaric acid, or combinations thereof. Non-nutritive acids used to modify the pH of a food may be distinguished from nutritive acids, such as ascorbic acid, amino acids, alpha-linoleic acid, alpha-lipoic acid, and the like, as well as certain mineral salts which may be used to provide nutritionally valuable minerals.

It has been found that in certain processed foods, such as breakfast cereals or pet foods, the use of a non-nutritive acidifying agent may contribute to an undesirable aroma. In particular, the use of acids such as phosphoric acid or hydrochloric acid in a starch matrix food in amounts effective to influence microbial growth may contribute to a sour smell that is unappealing. For reasons which are not entirely understood, this effect may be exacerbated if the food also includes added plasticizers, such as propylene glycol. The undesirable aroma may also be exacerbated if the food includes a non-nutritive acid and an artificial preservative, particularly if the preservative has a stringent or sour smell.

In some instances, dogs may be indifferent to the sour or fermented smell that results from using non-nutritive acids. However, cats and humans may find the smell objectionable or unappetizing. Of course, a human must purchase dog food, so a smell that is objectionable or unappetizing to the human may be commercially undesirable even in a dog food having a smell unobjectionable to most dogs. A human may anthropomorphically assume a sour or fermented smell will also be objectionable or unappetizing to a companion animal, such as a dog, or a human might not want to handle or store a food with a disagreeable aroma. As such, it may be undesirable for a food to have a sour or fermented smell to a human, even if the food is intended for non-human animals.

This creates a difficulty for manufacturers of processed foods. Oxidation of a food product over time can lead to the formation of aldehydes, which are also associated with unpleasant aroma. Oxidation is one of the causes of the distinctive odor of rancid fats, and may further degrade nutrients in a processed food. As a result, some processed foods are produced with additives that lend a sour or fermented smell to the food, this objectionable smell being preferable to unmitigated oxidation and/or microbial growth.

In the absence of compounds which may create undesirable aromas, it is possible to create a processed food product with a desirable, “toasty” aroma. In some embodiments, a processed food product comprises a protein source that is rich in carbohydrates. Without wishing to be bound by theory, it is believed that the use of carbohydrate-rich protein sources may facilitate Maillard Reactions during cooking due to the proximity of reducing sugars (possibly associated with larger carbohydrate molecules) and amino acids in the carbohydrate-rich protein source. Maillard Reactions are non-enzymatic browning reactions. Maillard Reaction products are complex, and are associated with generally desirable aromas like the smell of baking bread or grilling meat. When used in a processed food having a starch matrix, such as a pet food kibble or a breakfast cereal, Maillard Reactions may contribute to a mild, toasty aroma with grainy or grassy notes. This is generally a pleasant, or at least inoffensive, aroma.

Carbohydrate-rich protein sources will generally be of vegetable or microbial origin, and may include, for example, corn, soy, peas, other beans, cereals or legumes, yeast, algae, or combinations thereof. In contrast, most animal derived proteins, such as fish, chicken, beef, lamb, and the like, as whole products or as meal or by-product, contain relatively little carbohydrate. In some embodiments, a processed food may comprise at least 60% or at least 70% or at least 80% carbohydrate-rich protein sources. In some embodiments, a processed food may comprise protein-enriched fractions of cereals, legumes, or beans, such as corn gluten meal, corn protein concentrate, soy protein isolate, soy bean meal, soy protein concentrate, protein-rich fractions of other cereals, beans or legumes, or combinations thereof. A processed food may comprise at least 10% of a protein-enriched fraction of a cereal, legume, or bean. Even when concentrated, an enriched fraction of a cereal, legume, or bean may have higher carbohydrate content than a like weight of animal-derived protein.

The processed food may comprise a gelatinized starch matrix. The processed food may comprise less than 0.5% by weight of non-nutritive acid. The processed food may be free of non-nutritive acids. The processed food may have no added non-nutritive acids. In some embodiments, the processed food may be free of or have no added fumaric acid, lactic acid, oxalic acid, citric acid, malic acid, aspartic acid, adipic acid, ethyleneidaminetetraacetic acid (EDTA), phosphoric acid, tartaric acid, sulfuric acid, hydrochloric acid, chelating salts acidic in nature, or combinations thereof. The processed food may be free of or have no added artificial preservatives. In some embodiments, the processed food may be free of or have no added benzoates, including sodium benzoate, nitrites or nitrates, sulfites, polyphosphates, butylated hydroxyanisole or butylated hydroxytoluene (BHA/BHT), or combinations thereof.

The processed food may be free of added sugars. In some embodiments, the processed food may be free of added dextrose, fructose, fruit juice concentrate, glucose, maltose, invert sugar, malt syrup, caramel, corn syrup, high fructose corn syrup, corn syrup solids, molasses, corn sweetener, lactose, raw sugar, sucrose, sugar syrup, cane crystals, cane sugar, crystalline fructose, evaporated cane juice, and combinations thereof. In some embodiments, the processed food may comprise sources of reducing sugars to participate in Maillard Reactions, such as fruits or vegetables. The fruits or vegetables may be fresh, dried, powdered, frozen, freeze-dried, ground, or blended. Fruit or vegetable pomace may be used. Suitable fruits and vegetables include peas, spinach, tomatoes, pumpkin, blueberries, cranberries, apples, carrots, broccoli, celery, grapefruits, oranges, pears, bananas, blackberries, cantaloupe, kiwis, raspberries, strawberries, watermelon, asparagus, Brussels sprouts, cauliflower, cucumbers, green beans, sweet potatoes, potatoes, okra, apricots, mangoes, pineapples, cabbage, peaches, plums, beets, zucchini, avocados, and combinations thereof. One of ordinary skill in the art will appreciate that some parts of specific fruits or vegetables should be excluded from pet food, such as the pits or seeds of certain fruits, while other parts of the same fruit or vegetable may provide a low-fat energy source, vitamins and other nutrients, fiber, and/or reducing sugars useful in Maillard Reactions. One of ordinary skill in the art would use specific fruits and vegetables accordingly.

The processed food may be free of artificial colorants. The processed food may have no added artificial colorants. Artificial colorants include straight colors, lakes, and mixtures prepared in accordance with the U.S. Food Drug & Cosmetic Act. These artificial colorants may be identified, for example, as FD&C Blue No. 1, or Blue 1, or Blue 1 Lake. The artificial colorants may be chemically classified as azo, xanthene, triphenylmethane, or indigoid dyes. In some embodiments, the processed food is free of or has no added artificial colorants comprising a cation reagent or substratum.

In some embodiments, a processed food may be free of added plasticizers. In some embodiments, a processed food may have no added plasticizers. Plasticizers may be used to modify the texture or mouth feel of the processed food. Exemplary plasticizers include glycerin, polyols such as propylene glycol and butylene glycol, polyhydric glycols such as glycerol and sorbitol, and the like, as well as some gums (such as carboxymethyl cellulose) and proteins (such as gelatin) and combinations thereof. Several of these plasticizers have no distinct aroma, and the mechanism by which the plasticizer seems to exacerbate the sour or fermented smell associated with other additives is not fully understood. Some plasticizers also serve as humectants, and, without wishing to be bound by theory, it is speculated that the changes in texture and/or moisture content associated with a plasticizer may retard the dissipation of volatile components of other additives and prolong the duration of a sour or fermented smell created primarily by other additives. The possibility of a chemical reaction between plasticizers and other additives has not been ruled out.

In some embodiments, it may be desirable to enhance the content of anti-oxidants in the food. For example, it may be desirable to compound the food to provide increased levels of Vitamin E (or mixed tocopherols), Vitamin C, carotenoids, polyphenols, modified or derived forms thereof, or combinations of these. These compounds may serve a dual purpose. They may be nutritionally relevant to a human or animal who consumes the food, and may prevent or reduce oxidation of the food over time. These anti-oxidants may be manipulated by compounding the food to include natural sources of these compounds, such as selected fats, fruits, vegetables, or may be added separately to the food as a supplement. In some embodiments, the food has a Vitamin E content of at least 80 IU/Kg of food, or at least 150 IU/Kg of food, or at least 250 IU/Kg of food, or at least 500 IU/Kg of food. In some embodiments, the food has a Vitamin C content of at least 10 ppm, or at least 25 ppm, or at least 50 ppm, or at least 100 ppm. By way of comparison, the 2012 AAFCO Dog Food Nutrient Profile recites a minimum Vitamin E content of 50 IU/Kg (on a dry matter basis), and the 2012 AAFCO Cat Food Nutrient Profile recites a minimum Vitamin E content of 30 IU/Kg (on a dry matter basis). The 2012 AAFCO Nutrient Profiles for Dogs and Cats do not identify Vitamin C as a required nutrient. The higher Vitamin E level may be used with or in lieu of the Vitamin C. The Vitamin C may be used with or in lieu of the Vitamin E level. Carotenoids, polyphenols, and/or other nutritive anti-oxidants may be used with or in lieu of Vitamins E and/or C. Higher anti-oxidant content in the food may delay, reduce, or prevent oxidation, and, therefore, may help reduce or prevent the formation of aldehydes over time, which may negatively impact the aroma profile of the food.

In some embodiments, the processed food may comprise less than 10%, or less than 5%, or less than 3%, of rendered products of bovine or porcine origin. These products, including isolated fats of bovine or porcine origin, may contribute to fecal tones in the aroma of the food which can detract from or even overwhelm the grainy, toasty aroma associated with carbohydrate-rich protein sources. Rendered products can be distinguished from meat products, including unmodified or whole cuts of beef or pork, ground beef or pork, or shredded beef or pork. Dried meat or dried meat by-product meals may also have a less offensive odor than rendered products.

A food having a pleasant aroma may be prepared using any suitable method for initiating Maillard Reactions, such as extrusion cooking, baking, ohmic heating, retorting, and the like. The food may be coated after cooking, as with a glaze, fat, palatant, or other additions. In some embodiments, any coating or addition after the food is cooked is substantially free of animal digest or animal by-product, i.e., any coating or addition after the food is cooked comprises less than 50% by weight of the coating or addition animal digest or animal by-product. In some embodiments, any coating or addition after the food is cooked comprises less than 5% by weight of the coated or finished food animal digest or animal by-product. The food may be a dry food, having a moisture content of less than or equal to 12%, or a semi-moist food, having a moisture content of greater than 12% and less than 35%, or a wet food, having a moisture content of greater than 35%. The food may be intended for human ingestion, such as breakfast cereal, snack bars, snack chips or crisps, and the like. The food may be intended for ingestion by a pet. The food may be a dog food or a cat food. The food may be a complete diet for a companion animal. The food may be a treat, a food product intended for use with a complete diet for the purpose of enjoyment or reward. The food may be a supplement, a food product intended for use with a complete diet for the purpose of providing non-essential nutrients or substances such as medications, or for providing enhanced quantities of essential nutrients beyond the minimum levels required in a complete diet.

Some processed foods may be packaged with unlike foods. For example, a bag of snack crisps or pet food may comprise crisps or kibble of different compositions. Where the different compositions are packaged together, it may be desirable that none of the co-packaged products has an unappealing odor, because, over time, the unappealing odor may transfer to other food particles. Even if otherwise pleasant-smelling foods do not absorb an unappealing odor, the pleasant smell might not be appreciated by a consumer or pet because of the unappealing odor of one of the compositions. Thus, when preparing a processed food as a mixture of different compositions, it is desirable to evaluate each composition separately. As an example, a dry pet food may have 3 different kibbles, each with a different composition. Two of the kibbles may be provided as described herein, and have a pleasant, or at least inoffensive, aroma. The third kibble may include non-nutritive acid and a plasticizer, and have a sour or fermented smell. Each of the kibbles should be evaluated separately, and any proportional measurements, such as weight percentages, should be based on the weight of kibble of the same composition. That is, the percent of non-nutritive acid in the food composition should be calculated against the weight of the third kibble, not against the combined weight of all three kibbles.

### EXAMPLE 1

A dry dog food was prepared in kibble form as a complete diet. The food had label ingredients and guaranteed analysis as shown in Table 1. Samples of the diet were smelled by volunteers who described the food aroma as toasty, grainy, low aroma, and clean.

### EXAMPLE 2

A dry dog food was purchased in kibble form as a complete diet. The food had label ingredients and guaranteed analysis as shown in Table 1. Samples of the diet were smelled by volunteers who described the food aroma as sour, fermented, and slight fecal matter, with pungent, acid, acrid, artificial smell. Volunteers stated that the aroma fills the nose and lingers.

### EXAMPLE 3

A dry dog food was purchased in kibble form as a complete diet. The food had label ingredients and guaranteed analysis as shown in Table 1. Samples of the diet were smelled by volunteers who described the food aroma as pungent, acidic, acrid, and artificial.

### EXAMPLE 4

A dry dog food was purchased in kibble form as a complete diet. The food had label ingredients and guaranteed analysis as shown in Table 1. Samples of the diet were smelled by volunteers who described the food as having an intense aroma, with moderate fatty and fecal notes and less noticeable toasty note.

### EXAMPLE 5

A dry dog food was purchased in kibble form as a complete diet. The food had label ingredients and guaranteed analysis as shown in Table 1. Samples of the diet were smelled by volunteers who described the food as having a meaty, pungent, acidic, acrid, and artificial smell.

### EXAMPLE 6

A dry dog food was purchased in kibble form as a complete diet. The food had label ingredients and guaranteed analysis as shown in Table 1. Samples of the diet were smelled by volunteers who described the food as having an intense aroma, with moderate fatty/oily and fecal notes and less noticeable toasty note.

TABLE 1
GA and Labeled Ingredients for Examples 1-6

| Example | Guaranteed Analysis | Labeled Ingredients |
|---|---|---|
| 1 | Crude Protein (Min) 21.0% | Ground Yellow Corn, Chicken By-Product |
| | Crude Fat (Min) 10.0% | Meal, Soybean Meal, Animal Fat (preserved |
| | Crude Fiber (Max) 5.0% | with mixed Tocopherols, a source of Vitamin |
| | Moisture (Max) 10.0% | E), Chicken, Corn Gluten Meal, Dried Beet |
| | Linoleic Acid (Min) 1.9% | Pulp, Chicken Flavor, Salt, Calcium |
| | Calcium (Ca) (Min) 0.6% | Carbonate, Potassium Chloride, Choline |
| | Phosphorus (P) (Min) 0.5% | Chloride, Vegetable and Fruit Blend (Dried |
| | Iron (Fe) (Min) 225 mg/kg | Apple Pomace, Dried Carrots, Dried Peas, |
| | Zinc (Min) 160 mg/kg | Dried Spinach and Dried Tomatoes), |
| | Vitamin E (Min) 80 IU/kg | Vitamins (Vitamin E Supplement, Ascorbic |
| | | Acid, Vitamin A Acetate, Calcium |
| | | Pantothenate, Biotin, Thiamine |
| | | Mononitrate(source of Vitamin B1), Vitamin |
| | | B12 Supplement, Niacin, Riboflavin |
| | | Supplement (source of Vitamin B2), Inositol, |
| | | Pyridoxine Hydrochloride (source of Vitamin |
| | | B6), Vitamin D3 Supplement, Folic Acid), |
| | | Minerals (Ferrous Sulfate, Zinc Oxide, |
| | | Manganese Sulfate, Copper Sulfate, |
| | | Manganous Oxide, Potassium Iodide, Cobalt |
| | | Carbonate), Dicalcium Phosphate, Rosemary |
| | | Extract |
| 2 | Crude Protein Min 25.0% | Ground yellow corn, chicken by-product |
| | Crude Fat Min 10.0% | meal, corn gluten meal, whole wheat flour, |
| | Crude Fiber Max 4.0% | animal fat preserved with mixed-tocopherols |
| | Moisture Max 14.0% | (form of Vitamin E), rice flour, beef, soy |
| | Linoleic Acid Min 1.5% | flour, water, meat and bone meal, propylene |
| | Calcium Min 1.1% | glycol, sugar, tricalcium phosphate, |
| | Iron Min 175 mg/kg | phosphoric acid, salt, animal digest, |
| | Selenium Min 0.2 mg/kg | potassium chloride, sorbic acid (a |
| | Vitamin A Min 10,000 IU/kg | preservative), dried peas, dried carrots, |
| | Vitamin E Min 100 IU/kg | calcium propionate (a preservative), choline |
| | | chloride, 1-Lysine monohydrochloride, |
| | | Vitamin E supplement, zinc sulfate, red 40, |
| | | ferrous sulfate, manganese sulfate, niacin, |
| | | yellow 6, yellow 5, Vitamin A supplement, |
| | | blue 2, calcium carbonate, copper sulfate, |
| | | Vitamin B-12 supplement, brewers dried |
| | | yeast, calcium pantothenate, thiamine |
| | | mononitrate, garlic oil, pyridoxine |
| | | hydrochloride, riboflavin supplement, |
| | | Vitamin D-3 supplement, menadione sodium |
| | | bisulfite complex (source of Vitamin K |
| | | activity), calcium iodate, folic acid, biotin, |
| | | sodium selenite |
| 3 | Crude Protein (Min) 18.0% | Ground yellow corn, ground wheat, soybean |
| | Crude Fat (Min) 9.0% | meal, meat and bone meal, animal fat |
| | Crude Fiber (Max) 3.5% | preserved with mixed-tocopherols (form of |
| | Moisture (Max) 14.0% | Vitamin E), egg and chicken flavor, chicken |
| | Linoleic Acid (Min) 1.2% | by-product meal, corn germ meal, corn gluten |
| | Calcium (Ca) (Min) 1.2% | meal, propylene glycol, animal digest, |
| | Phosphorus (P) (Min) 1.0% | phosphoric acid, sugar, salt, potassium |
| | Selenium (Se) (Min) 0.2 mg/kg | chloride, sorbic acid (a preservative), calcium |
| | Vitamin A (Min) 10,000 IU/kg | propionate (a preservative), choline chloride, |
| | Vitamin E (Min) 100 IU/kg | tricalcium phosphate, Red 40, zinc sulfate, |
| | | Yellow 5, Vitamin E supplement, ferrous |
| | | sulfate, manganese sulfate, niacin, Blue 2, |
| | | Vitamin A supplement, calcium carbonate, |
| | | copper sulfate, Vitamin B-12 supplement, |
| | | calcium pantothenate, thiamine mononitrate, |
| | | garlic oil, pyridoxine hydrochloride, |
| | | riboflavin supplement, Vitamin D-3 |
| | | supplement, calcium iodate, menadione |
| | | sodium bisulfite complex (source of Vitamin |
| | | K activity), folic acid, biotin, sodium selenite |
| 4 | Crude Protein (Min) 21% | Whole grain corn, poultry by-product meal, |
| | Crude Fat (Min) 10% | corn gluten meal, animal fat preserved with |
| | Crude Fiber (Max) 4.5% | mixed-tocopherols (form of Vitamin E), meat |
| | Moisture (Max) 12% | and bone meal, soybean meal, egg and |
| | Linoleic Acid (Min) 1.5% | chicken flavor, whole grain wheat, animal |
| | Calcium (Ca) (Min) 1% | digest, salt, calcium carbonate, calcium |
| | Phosphorus (P) (Min) 0.8% | phosphate, potassium chloride, choline |
| | Vitamin A (Min) 10,000 IU/kg | chloride, L-Lysine monohydrochloride, L- |
| | Ascorbic Acid (Min) 70 mg/kg | ascorbyl-2-polyphosphate (source of Vitamin |
| | | C), zinc sulfate, Vitamin E supplement, |
| | | ferrous sulfate, Yellow 6, Yellow 5, |
| | | manganese sulfate, niacin, Red 40, Vitamin A |
| | | supplement, Blue 2, copper sulfate, calcium |
| | | pantothenate, garlic oil, pyridoxine |
| | | hydrochloride, Vitamin B-12 supplement, |
| | | thiamine mononitrate, Vitamin D-3 |
| | | supplement, riboflavin supplement, calcium |
| | | iodate, menadione sodium bisulfite complex |
| | | (source of Vitamin K activity), folic acid, |
| | | biotin, sodium selenite |
| 5 | CRUDE PROTEIN, Min 19.0% | Corn, soybean meal, beef and bone meal, |
| | CRUDE FAT, Min 8.0% | ground wheat flour, animal fat (BHA used as |
| | CRUDE FAT, Max 12.0% | preservative), corn syrup, wheat middlings, |
| | MOISTURE, Max 18.0% | water sufficient for processing, animal digest |
| | CRUDE FIBER, Max 4.0% | (source of chicken flavor), propylene glycol, |
| | PHOSPHORUS, Min 0.76% | salt, hydrochloric acid, potassium chloride, |
| | VITAMIN A, Min 5100 IU/kg | caramel color, sorbic acid (used as a |
| | VITAMIN D, Min 500 IU/kg | preservative), sodium carbonate, minerals |
| | CALCIUM, Min 1.0% | (ferrous sulfate, zinc oxide, manganous oxide, |
| | ZINC, Min 125 mg/kg | copper sulfate, calcium iodate, sodium |
| | | selenite), vitamins (vitamin E supplement, |
| | | vitamin A supplement, niacin supplement, D- |
| | | calcium pantothenate, riboflavin supplement, |
| | | pyridoxine hydrochloride, thiamine |
| | | mononitrate, vitamin D3 supplement, folic |
| | | acid, biotin, vitamin B12 supplement), |
| | | choline chloride, calcium sulfate, titanium |
| | | dioxide (color), yellow 5, yellow 6, red 40, |
| | | BHA (used as a preservative), DL- |
| | | methionine. |
| 6 | Crude Protein Min 21.0% | Ground whole corn, meat and bone meal, corn |
| | Crude Fat Min 10.0% | gluten meal, animal fat (preserved with |
| | Crude Fiber Max 4.0% | bha/citric acid), soybean meal, ground whole |
| | Moisture Max 12.0% | wheat, brewers rice, dried plain beet pulp, |
| | Linoleic Acid Min 3.0% (omega | natural flavor, salt, vegetable oil ([source of |
| | 6 Fatty Acid) | linoleic acid] preserved with bha/bht), |
| | Copper Min 10 mg/kg | potassium chloride, vitamins (choline |
| | Zinc Min 200 mg/kg | chloride, a-tocopherol acetate [source of |
| | Vitamin E Min 300 IU/kg | vitamin e], niacin, biotin, d-calcium |
| | Ascorbic Acid (Vit. C) Min 70 Mg/kg | pantothenate, riboflavin supplement [vitamin |
| | | b2], pyridoxine hydrochloride, vitamin a |
| | | supplement, vitamin b12 supplement, |
| | | thiamine mononitrate [vitamin b1], vitamin |
| | | d3 supplement) minerals (zinc sulfate, zinc |
| | | proteinate, copper sulfate, potassium iodide, |
| | | copper proteinate, manganese proteinate), |
| | | added fd&c colors (red 40, yellow 5, blue 2). |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A processed food comprising at least 60% by weight one or more carbohydrate-rich protein sources, wherein the processed food comprises less than 0.5% by weight of non-nutritive acid and less than 5% by weight rendered products of bovine or porcine origin.

2. The processed food of claim 1, wherein the processed food is free of non-nutritive acid.

3. The processed food of claim 1, wherein the processed food is free of artificial preservatives selected from the group consisting of benzoates, nitrites or nitrates, sulfites, polyphosphates, butylated hydroxyanisole or butylated hydroxytoluene (BHA/BHT), and combinations thereof.

4. The processed food of claim 1, wherein the processed food is free of added sugars.

5. The processed food of claim 1, further comprising a fruit or a vegetable.

6. The processed food of claim 1, wherein the processed food is free of artificial colorants.

7. The processed food of claim 5, wherein the processed food is free of artificial colorants comprising a cation reagent or substratum.

8. The processed food of claim 1, wherein the processed food is free of plasticizers.

9. The processed food of claim 1, wherein the processed food is free of plasticizers selected from the group consisting of glycerin, polyols, polyhydric glycols, carboxymethylcellulose, gelatin, and combinations thereof.

10. The processed food of claim 1, further comprising Vitamin C.

11. The processed food of claim 10, further comprising at least 80 IU/Kg of Vitamin E and at least 25 ppm of Vitamin C.

12. The processed food of claim 1, wherein the carbohydrate-rich protein source is selected from the group consisting of corn, soy, peas, other cereals, beans or legumes, and combinations thereof.

13. The processed food of claim 1, wherein the carbohydrate-rich protein source comprises a protein-enriched fraction of a cereal, legume, or bean.

14. The processed food of claim 14, wherein the processed food comprises at least 10% by weight of the protein-enriched fraction of a cereal, legume, or bean and at least 60% by weight of one or more other carbohydrate-rich protein sources.

15. The processed food of claim 14, wherein the carbohydrate-rich protein source comprises corn gluten meal, corn protein concentrate, or combinations thereof.

16. The processed food of claim 14, wherein the carbohydrate-rich protein source comprises soy protein isolate, soybean meal, soy protein concentrate, or combinations thereof.

17. The processed food of claim 1, wherein the processed food is a complete diet for a dog.

18. The processed food of claim 18, wherein the food has a coating applied after cooking, and the coating is substantially free of animal digest or animal by-product.

19. The processed food of claim 1, wherein the processed food is a complete diet for a cat.

20. A method for providing or maintaining an inoffensive aroma in a processed food, the method comprising compounding a food which comprises carbohydrate-rich protein sources, and excluding from the food non-nutritive acid in an amount greater than 0.5% by weight of the food, and excluding from the food rendered products of bovine or porcine origin in an amount greater than 5% by weight of the food.
